(19) United States
(12) Patent Application Publication
(10) Pub. No.: US 2022/0414551 A1
(43) Pub. Date: Dec. 29, 2022

(54) Mobile App for Sporting Events/Concerts

(71) Applicant: Charles Derr, Voorhees, NJ (US)

(72) Inventor: Charles Derr, Voorhees, NJ (US)

(21) Appl. No.: 17/809,395

(22) Filed: Jun. 28, 2022

Related U.S. Application Data
(60) Provisional application No. 63/215,655, filed on Jun. 28, 2021.

(51) Int. Cl. G06Q 10/02; G06Q 50/00; G06F 3/0484; G06F 16/335

(52) U.S. Cl. CPC G06Q 10/02; G06Q 50/01; G06F 3/0484; G06F 16/337

(57) ABSTRACT

The present invention provides a system and method for performing an online registration process to obtain registration information and venue information, accessing one or more sources of information about venues, and providing a user interface that includes venue information, a venue map, a location of a user, a location of user's friends on the venue map, and a calendar window for showing various events.

### FIELD OF THE INVENTION

The present invention generally relates to systems, methods, and computer program products. More specifically, the present invention relates to a computer program that provides fans with seating and other information, such as the locations of concessions, restrooms, and ATMs within a sports venue.

### BACKGROUND OF THE INVENTION

A system for providing fans with seating and other information at a sports venue is in demand. With advances in technology, people are now able to buy, sell, and transfer goods and services online. Global computer systems and networks provide an efficient and cost-effective medium for people to interact with others while advertising and purveying their goods.

Sports events can be watched through smartphones, and tickets to various events can be purchased online. Electronic commerce companies use the Internet to offer, sell, and distribute a wide variety of goods, taking advantage of the many benefits of electronic commerce.

Currently, the sports event industry provides many online interfaces for fans, including apps showing seating at venues such as stadiums. In some cases, such programs allow online viewing of events in real time, permitting communication with event organizers or other event participants. However, such programs are designed for online users and might not be useful when people are actually present at a venue. For example, such programs cannot be used to find concessions, restrooms, or ATMs near a user's seating location. Accordingly, a system is needed that provides such information.

The present invention is intended to address problems associated with and/or otherwise improve on conventional systems through an innovative system that is designed to provide a convenient and effective means of providing sports event information, including details about seating and other local physical and nonphysical amenities within the sports venue while incorporating other problem-solving features.

### SUMMARY

In accordance with the present invention, a novel system and method are provided. The present invention comprises steps of performing an online registration process to obtain registration information and venue information, accessing one or more sources of information about venues, providing a user interface, wherein the user interface includes venue information, a venue map, a location of a user, and at least one friend when the location of the user matches the user's seat location on the venue map. The user interface may also include a calendar window for showing events.

In some embodiments, the present invention includes a process for connecting the user with user's friends. The present invention may include a mechanism for recognizing the seat location of user's friends and notifying the user of whether any friends are online when the user is online.

### BRIEF DESCRIPTION OF THE DRAWINGS

FIG. 1 is an illustration of one embodiment of the present invention.

FIG. 2 is an illustration of one embodiment of the registration and venue step of the present invention.

FIG. 3 is an illustration of one embodiment of the present invention in a network environment.

FIG. 4 is a flow diagram showing one embodiment of the present invention.

FIG. 5 is an illustration of one embodiment of a homepage and a user interface of the present invention.

### DETAIL DESCRIPTIONS OF THE INVENTION

All illustrations of the drawings are for the purpose of describing selected versions of the present invention and are not intended to limit the scope of the present invention.

All illustrations of the drawings are for the purpose of describing selected versions of the present invention and are not intended to limit the scope of the present invention.

The present invention provides a mobile app (“Seat It”) that allows fans to see where their seating section is along with locations of concessions, restrooms, ATMs, and more. The present invention also allows fans to check into their actual seat (by username) while connecting with friends and building a fan network.

The present invention allows a user to sign in using a username and password.

On its homepage, it lists a user's friends and visited stadiums as well as background information on favorite teams and allows the user to adjust app settings, sign out, and more.

After entering the venue, the user's location is displayed as a blip on the venue map along with all the venue's amenities. Users can take photos and save virtual tickets in the cloud, synced to an in-app calendar for export, or create their own nonfungible tokens (NFTs) of tickets. (NFTs are a type of digital asset designed to prove ownership of a unique virtual item, such as online pictures and videos or even sports trading cards.)

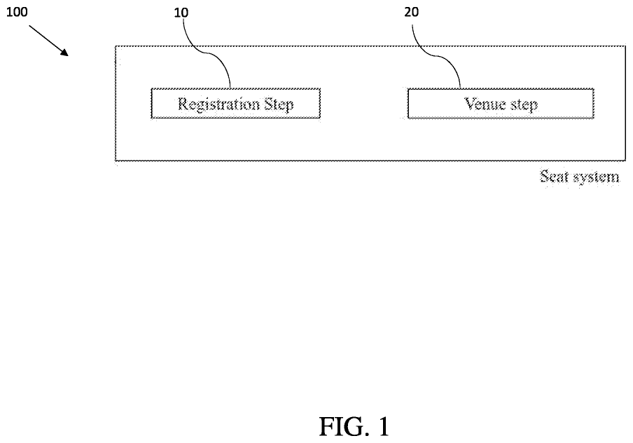

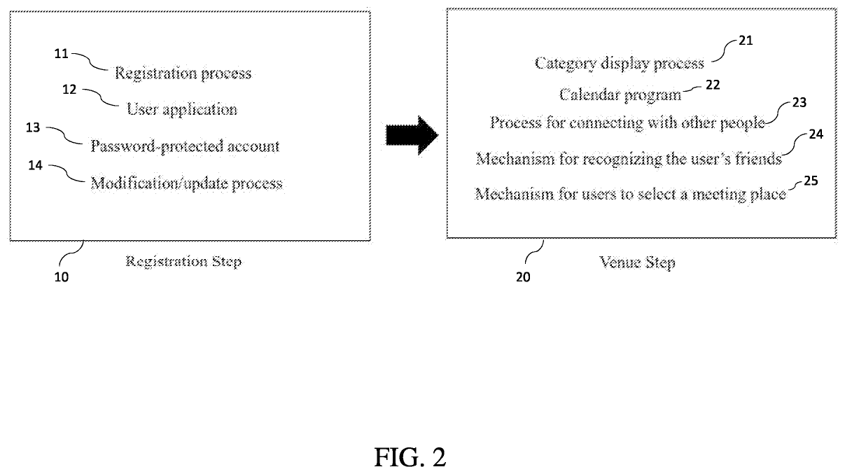

As FIGS. 1-2 show, the present invention provides a seat system 100 that comprises a plurality of processors and a plurality of memories, the latter of which contain instructions that when executed by a processor trigger a registration step 10 and a venue step 20. The instructions may include routines, programs, objects, data structures, and the like.

The seat system 100 can be implemented in a network environment, which may comprise one or more servers or one or more data stores. In some embodiments, the seat system 100 of the present invention can be loaded on a user's computing device 75, which may be communicatively connected to a network.

In other embodiments, the seat system 100 may be deployed on a computing device such that the seat system 100 is configured as a cloud system.

The registration step 10 and venue step 20 can be connected to each other to allow them to exchange information and can be communicatively connected to various other hardware devices that allow retrieval and transfer of information, such as cameras, microphones, and sensors.

### The Registration Step 10

The registration step 10 may include a process for initializing the seat system 100 so that a user 70 can interact with friends or retrieve event information. The user 70 can also be one of the friends that register with the seat system 100.

As shown in FIG. 2, the registration step 10 may include a registration process 11 (online registration process), which may include an online registration display (e.g., registration form) that allows a user 70 to input registration information such as company information, personal information, friend information (name and image), preferences, favorite sports team, and venue information (which includes a name of the venue, location of the venue 60, venue type, venue business hours, venue map and any other venue related information such as locations of concessions, restrooms, and ATM machines within the venue map).

In some embodiments, the registration step 10 may include a payment or subscription mechanism for users 70.

In some embodiments, the registration step 10 may provide a user application 12 through which the users 70 can join an event at its beginning. This user application 12 may be configured to retrieve user information and allow users 70 to sign into the seat system 100. The user application 12 may include AI/machine learning (ML) processes using various computing languages. The user application 12 may be configured to retrieve user information such as location, interests, name, and other personal information.

In one embodiment, the registration step 10 may provide a password-protected account 13 for each user 70. In other embodiments, it may also provide a verification mechanism for user authentication.

In some embodiments, registration information 10 can be stored on the user's computing device 75 or on any server communicatively connected to it.

In some embodiments, the registration step 10 may include a modification/update process 14 whereby users 70 can modify and update their personal information.

### The Venue Step 20

The venue step 20 may include one or more processes that display venue and other related information online based on the information gathered in the registration step 10.

In some embodiments, information related to the user's specified venue 60 (including all vendors at the venue) can be downloaded from a source (e.g., within the sports event industry) available over a computer network.

In some other embodiments, a server 40 communicatively connected to the user's computing device 75 may access databases or information from various sources or service providers, e.g., a ticket distribution company or any local online entertainment city guide. For example, the server 40 may access a database that includes information about citywide events or venues and may collect the venue and/or event information in real time or periodically.

As shown in FIG. 2, the venue step 20 may include a category display process 21 through which to organize information for display on the screen of a user's computing device 75.

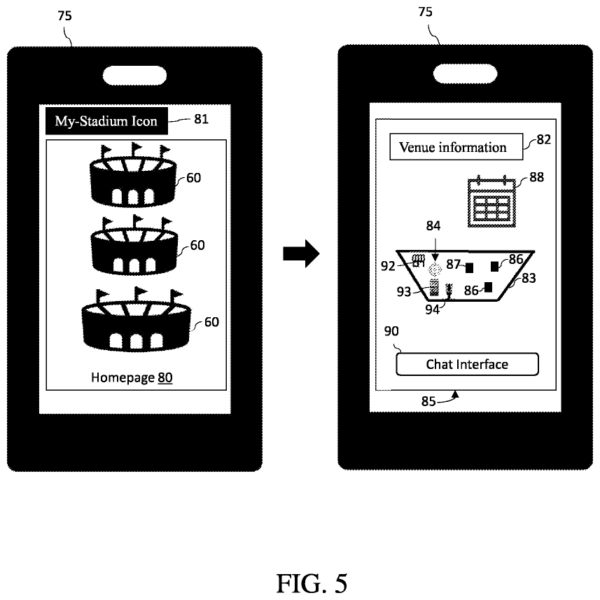

In one embodiment, the category display process 21 may include a web display of the venue with local physical information concerning concessions 92, ATM machines 93 restrooms 94 within a venue (as shown in FIG. 5).

In some embodiments, the present invention can be connected to a calendar program 22 so that users 70 can organize registration dates and future event planning dates along with related images.

In some other embodiments, the present invention can include a program configured to function as a calendar.

In some embodiments, the web display can include various venue information input by the user 70 during the registration step 10.

The venue step 20 may include a process for connecting with other people, such as the user's friends. In such embodiments, the venue step 20 may include a mechanism for recognizing the user's friends 24 (e.g., by comparing name or personal information) and notifying the user of whether any friends are online when the user is online.

The venue step 20 may be configured to provide real-time interactive communication between the user 70 and friends using any chat technology known in the art that can provide one or more chat clients configured to open a connection over the Internet with a server 40 (e.g., a remote chat server) to enable a chat session to occur.

In some embodiments, the user 70 may be able to interact with a friend using a chat service provided by a third party.

The server 40 (that includes a remote chat server) connected to network 200 (e.g., Internet) can be any chat server that may host chat sessions between the user 70 and the friends.

In some embodiment, the server 40 (remote chat server) may be maintained by a third-party enterprise.

The venue step 20 may include a process to provide a user interface 85 and cause a chat interface 90 (as shown in FIG. 5) to appear within the user interface 85, wherein the chat interface 90 is smaller than the user interface 85. The venue step 20 may include a process to launch a chat session and send invitations to chat to at least one friend based on the information gathered in the registration step 10. The venue step 20 may further include a process to list identification of friends who accepted the invitation in the chat session and entered the chat session.

In some embodiments, the venue step 20 may be configured to conditionally display user information (such as names and images) and information about friends along the perimeter of a display screen provided by a user's computing device 75. For example, the user 70 may be required to check into the desired seat, and the venue step 20 may show a list of friends available near that seat.

In some other embodiments, the venue step 20 of the present invention may include a mechanism for users 70 to select a meeting place 25 in the venue or place a blip pinpointing a location on the venue map, allowing the user 70 to arrange to meet friends at the specified location.

In some other embodiments, the present invention can be configured to use instant messaging services, for instance, of Yahoo and Skype. The present invention may also allow uploading/storing of pictures associated with each calendar date to outside sources or a data storage medium for later download, to create personal NFTs or to print via third-party sites or systems.

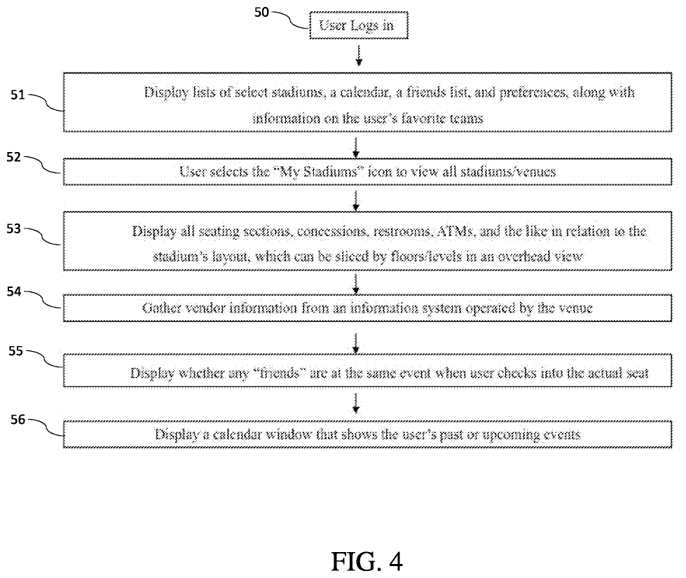

FIG. 4 is a flowchart of one embodiment of the venue step 20 of the seat system 100. After the user 70 logs in 50 (with a username/password combination), the user 70 may see a homepage. At 51, the present invention may display lists of select stadiums (input by the user during the registration step), a calendar, a friends list, and preferences, along with information on the user's favorite teams.

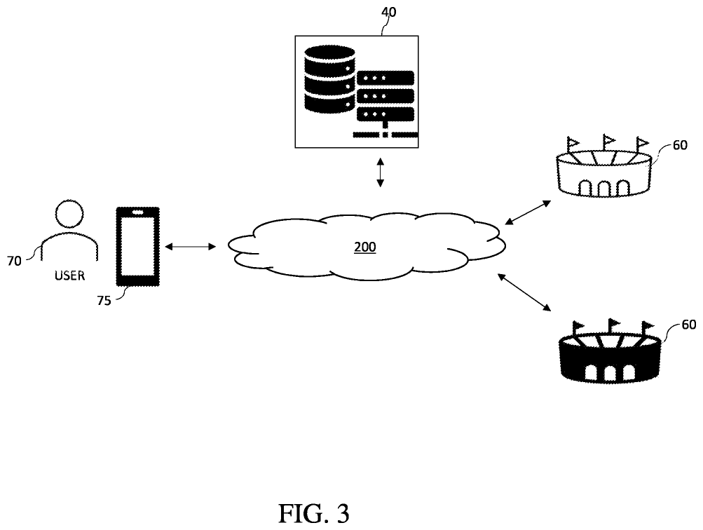

At 51, the user 70 may select the “My Stadiums” icon to view all stadiums/venues. In some embodiments, as shown in FIG. 3, each venue can be downloaded as needed from an outside source. After user 70 selects a stadium/venue, at 53, the present invention may display all seating sections, concessions 92, restrooms 94, ATMs 93, and the like in relation to the stadium's layout, which can be sliced by floors/levels in an overhead view.

In some embodiments, the present invention may show the user 70 as a blip on the venue map. At 54, all vendor information can be gathered from an information system operated by the venue. At 55, the present invention may display whether any “friends” are at the same event by checking in to the actual seat. In some embodiments, the user 70 may be allowed to place a blip on the venue map to select a meeting place. At 56, the present invention may display a calendar window that shows the user's past or upcoming events.

In preferred embodiment, the seat system 100 of the present invention performs an online registration process (registration process 11) to obtain registration information that includes at least one name of a friend and venue information, and accesses one or more sources of information about venues provided in the venue information.

Then, as shown in FIG. 5, the seat system 100 provides a homepage 80 with a my-stadium icon 81 (the “My Stadiums” icon) that is configured, when selected by the user 70, to present at least one stadium (venue 60), wherein the at least one stadium can be in a form of a name of the stadium (venue 60) and/or an image of the stadium (venue 60). If the at least one stadium (venue 60) is selected by the user 70, the seat system 100 provides at least one user interface 85 (including a graphical user interface (GUI)) that comprises venue information 82, a venue map 83 of the at least one stadium (venue 60), a location of the user 84 on the venue map 83, a location of at least one friend 86 when the location of the user 84 matches the user's seat location 87 on the venue map 83, and a calendar window 88 for showing events.

The steps and the processes described in connection with the embodiments disclosed herein can be embodied directly in hardware, in a software module executed by a processor, or in a combination of the two. A software module can reside in a memory unit that can include volatile memory, non-volatile memory, and network devices, or other data storage devices now known or later developed for storing information/data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type. In example embodiments, network can be configured to provide and employ 5G wireless networking features and functionalities.

Although the invention has been explained in relation to its preferred embodiment, it is to be understood that many other possible modifications and variations can be made without departing from the spirit and scope of the invention.

What is claimed is:

1. A method comprising:
performing an online registration process to obtain registration information that includes at least one name of a friend and venue information;
accessing one or more sources of information about venues;
providing a homepage with a my-stadium icon that, when selected, presents at least one stadium;
if one of the at least one stadium is selected,
providing at least one user interface comprising:
the venue information;
a venue map of the at least one stadium;
a location of a user on the venue map;
a location of at least one friend when the location of the user matches the user's seat location on the venue map; and
a calendar window for showing events.

2. The method as claimed in claim 1, wherein the registration information includes at least one name of a friend

3. The method as claimed in claim 1, wherein the venue information includes locations of the venues.

4. The method as claimed in claim 1, wherein the venue information includes locations of concessions, restrooms, and ATM machines within the venue map.

5. The method as claimed in claim 1, further includes providing a user application configured to retrieve user information by using machine learning techniques.

6. The method as claimed in claim 1, further includes providing at least one password-protected account.

7. The method as claimed in claim 1, further includes receiving a meeting location within the venue map and displaying the meeting location.

8. The method as claimed in claim 1, further includes causing a chat interface to appear within the user interface, wherein the chat interface is smaller than the user interface, launching a chat session, and sending invitations to chat to at least one friend.

9. The method as claimed in claim 8, further includes listing identification of friends who accepted the invitation in the chat session and entered the chat session.

10. The method as claimed in claim 1, further includes storing at least one image on a data storage medium.

11. A non-transitory computer readable medium containing computer-readable instructions stored therein for causing a computer processor to perform operations to:
perform an online registration process to obtain registration information that includes at least one name of a friend and venue information;
access one or more sources of information about venues;
provide a homepage with a my-stadium icon that, when selected, presents at least one stadium;
if one of the at least one stadium is selected,
provide at least one user interface comprising:
venue information;
a venue map of the at least one stadium;
a location of a user on the venue map;
a location of at least one friend when the location of the user matches the user seat location on the venue map; and
a calendar window for showing events.

12. The method as claimed in claim 11, wherein the registration information includes at least one name of a friend.

13. The method as claimed in claim 11, wherein the venue information includes locations of the venues.

14. The method as claimed in claim 11, wherein the venue information includes locations of concessions, restrooms, and ATM machines within the venue map.

15. The method as claimed in claim 11, further includes providing a user application configured to retrieve user information by using machine learning techniques.

16. The method as claimed in claim 11, further includes providing at least one password-protected account.

17. The method as claimed in claim 11, further includes receiving a meeting location within the venue map and displaying the meeting location.

18. The method as claimed in claim 11, further includes causing a chat interface to appear within the user interface, wherein the chat interface is smaller than the user interface, launching a chat session, and sending invitations to chat to at least one friend.

19. The method as claimed in claim 18, further includes listing identification of friends who accepted the invitation in the chat session and entered the chat session.

20. The method as claimed in claim 11, further includes storing at least one image on a data storage medium.
